(19) United States
(12) Patent Application Publication
(10) Pub. No.: US 2004/0093421 A1
(43) Pub. Date: May 13, 2004

(54) Method, system and communication node for improving the throughput on WLAN and k-DCF protocol

(76) Inventors: Yong Peng, Beijing (CN); Shiduan Cheng, Beijing (CN); Dongmei Zhang, Beijing (CN); Jian J. Ma, Beijing (CN); Haitao Wu, Beijing (CN)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/289,404

(22) Filed: Nov. 7, 2002

(51) Int. Cl. G06F 15/16

(52) U.S. Cl. 709/232

(57) ABSTRACT

A method of enhancing the throughput in a wireless communication network with an algorithm, wherein the algorithm is self-adapting to the current network load; a collision related parameter is calculated and exchanged for refreshing the state of the network; and an optimal contention window for a transmission of packets is calculated by using the collision related parameter and an initial contention window.

### BACKGROUND OF THE INVENTION

1. Field of the invention

The present invention relates to a method, system and communication node for enhancing the throughput in a wireless communication network such as a wireless local area network (WLAN).

2. Related Background Art

The IEEE 802.11 protocol based wireless local area network (WLAN) is an important local access method of the wireless communication, wherein the distributed coordination function (hereinafter: DCF) algorithm is the basic access method of IEEE 802.11.

The DCF algorithm with Request-to-Send (RTS)/Clear-to-Send (CTS) control packets is shown in FIG. 1, where SIFS designates a Short InterFrame Space, NAV designates a Network Allocation Vector, and DIFS designates a Distributed (Coordination Function) InterFrame Space. The DCF window backoff algorithm (here, “backoff” means the delay in transmission after a collision in the network) is defined as follows:

a) initial contention window calculation:

Wᵢₙᵢ=Wₘᵢₙ; (1)

b) contention window exponential backoff:

Wⱼ=Wⱼ₋₁ *2+1; if (Wⱼ>Wₘₐₓ)Wⱼ=Wₘₐₓ; (2)

c) Backoff Time=Random() *aSlotTime,

Random()uniformly distributed between [0, W], (3)

wherein W, Wⱼ represent the medium access control (MAC) contention window value, i.e. the maximum number of unconfirmed outstanding data blocks, and Wₘᵢₙ and Wₘₐₓ represent the up and down limit of the contention window.

However, the recent research has shown that the known DCF algorithm shows low performance, especially a low throughput, in case of a heavy contention environment.

The problem of the DCF algorithm performance in a heavy contention environment can further be differentiated as follows:

Case 1: The ratio between collision time length and free time length is smaller than optimal. The reason is that the current contention window is too big when compared to a current media load and has caused an unnecessary backoff delay. As the initial contention window is rather small, this case is unusual.

Case 2: In a heavy contention environment, the ratio between the collision time length and the free time length is bigger than optimal. The reason is that the current contention window is too small when compared to a current media load and one successful transmission of a data frame often experience many times of collision. In this case, the contention window of the nodes that encountered collision remain on a high level in a certain period and those nodes have less possibility of obtaining access to the wireless media compared to those nodes without collision. As a result, the fairness of the wireless access is weakened.

In order to relieve the contention, there has been proposed the window exchange algorithm.

Further, it has been proposed to obtain differentiated services between wireless nodes by giving them different Quality-of-Service (QpS) parameters.

However, these algorithms suffer from the drawback that they cannot self-adapt to the current contention level.

Still further, is has been attempted to design a self-adapting algorithm such as the Asymptotically Optimal Backoff (AOB) mechanism by L. Bononi, M. Conti, E. Gregori (“Design and Performance Evaluation of an Asymptotically Optimal Backoff Algorithm for IEEE 802.11 Wireless LANs”, Proceedings of the 33^{rd} Annual Hawaii International Conference on System Sciences, 2000).

However, this mechanism includes a contention level function taking a packet length as a parameter, which is unnecessary and leads to inaccuracy.

### SUMMARY OF THE INVENTION

The present invention overcomes the shortcomings of the prior art, i.e. improves the throughput in a wireless communication network and guarantees the fairness of the node access.

The present invention is a method of enhancing the throughput in a wireless communication network with an algorithm, wherein the algorithm is self-adapting to the current network load; a collision related parameter is calculated and exchanged for refreshing the state of the network; and an optimal contention window for a transmission of packets is calculated by using the collision related parameter and an initial contention window.

As an implementation of the present invention, there is provided a modification of the known DCF algorithm, which is named k-DCF protocol and improves the throughput in WLAN (Wireless local area network) and also guarantees the fairness of the node access.

The design of this protocol is based on the calculation of the collision related parameter, which parameter is here named as “k”, and the k-DCF algorithm is self-adapting to the current wireless link load.

According to the present invention, the self-adapting problem of the known DCF algorithm in heavy contention level environment is solved by deriving a simple equation of an optimal contention window (Wₒₚₜ), the collision related parameter (k), an optimal value of the collision related parameter (kₒₚₜ) and a current contention window (W). The algorithm is both simple and efficient compared to the previous research on this field.

In a presently preferred embodiment of the method according to the present invention, the network comprises a plurality of communication nodes, and the method comprises the following steps concerning each of the communication nodes: in a state where a respective communication node is not sending packets, detecting busy and idle periods of a current wireless link; and in a state where the respective communication node is sending packets, calculating first a new value for a collision related parameter (k) according to the lengths of the detected busy and idle periods; sending a request to send packets including the calculated new value for the collision related parameter (k), whereby a respective network state is refreshed and other communication nodes retrieve the value for the collision related parameter (k); resetting an initial contention window (wᵢₙᵢ) by utilizing the calculated new value for the collision related parameter (k); and calculating a current contention window (W) for the transmission of packets by utilizing the initial contention window (Wᵢₙᵢ).

The method according to the present invention may comprise the further steps of: in the state where the respective communication node is not sending packets, receiving a packet of another communication node including a value for the collision related parameter (k); and refreshing, in the respective communication node, a value for the collision related parameter (k) according to the received value.

The present invention is also a system for enhancing the throughput in a wireless communication network with an algorithm, comprising means for performing the algorithm in a manner so as to be self-adapting to the current network load; means for calculating a collision related parameter (k) and to exchange the collision related parameter (k) for refreshing the state of the network; and means for calculating an optimal contention window (Wₒₚₜ) for a transmission of packets by using the collision related parameter (k) and an initial contention window (Wᵢₙᵢ).

Preferably, in the system according to the present invention, the network comprises a plurality of communication nodes, and each of the communication nodes comprises: means for detecting busy and idle periods of a current wireless link; means for first calculating a new value for a collision related parameter (k) according to the lengths of the detected busy and idle periods; means for sending a request to send packets including the calculated new value for the collision related parameter (k); means for retrieving the value for the collision related parameter (k); means for resetting an initial contention window (Wᵢₙᵢ) by utilizing the calculated new value for the collision related parameter (k); and means for calculating a current contention window (W) for the transmission of packets by utilizing the initial contention window (Wᵢₙᵢ).

Preferably, in the system according to the present invention, each of the communication nodes further comprises: means for receiving a packet of another communication node including a value for the collision related parameter (k); and means for refreshing a value for the collision related parameter (k) according to the received value.

As an implementation of the system according to the present invention, the system performs the k-DCF algorithm according to the present invention.

The present invention is also a communication node for enhancing the throughput in a wireless communication network with an algorithm, comprising means for performing the algorithm in a manner so as to be self-adapting to the current network load; means for calculating a collision related parameter and to exchange the collision related parameter for refreshing the state of the network; and means for calculating an optimal contention window for a transmission of packets by using the collision related parameter and an initial contention window.

Preferably, the communication node according to the present invention has the k-DCF algorithm implemented.

The present invention is also another communication node for enhancing the throughput in a wireless communication network with an algorithm, comprising: means for detecting busy and idle periods of a current wireless link; means for first calculating a new value for the collision related parameter (k) according to the lengths of the detected busy and idle periods; means for sending a request to send packets including the calculated new value for the collision related parameter (k); means for retrieving the value for the collision related parameter (k); means for resetting an initial contention window (Wᵢₙᵢ) by utilizing the calculated new value for the collision related parameter (k); and means for calculating a current contention window (W) for the transmission of packets by utilizing the initial contention window (Wᵢₙᵢ).

Preferably, this other communication node further comprises: means for receiving a packet of another communication node including a value for the collision related parameter (k); and means for refreshing a value for the collision related parameter (k) according to the received value.

The above communication nodes according to the present invention may also be implemented as the same communication node.

### BRIEF DESCRIPTION OF THE DRAWINGS

Further details and advantages of the present invention will become apparent from the following detailed description of the preferred embodiments which are to be taken in conjunction with the appended drawings, in which:

FIG. 1 shows a DCF access mode according to the prior art with Request-to-Send (RTS) and Clear-to-Send (CTS) control packets;

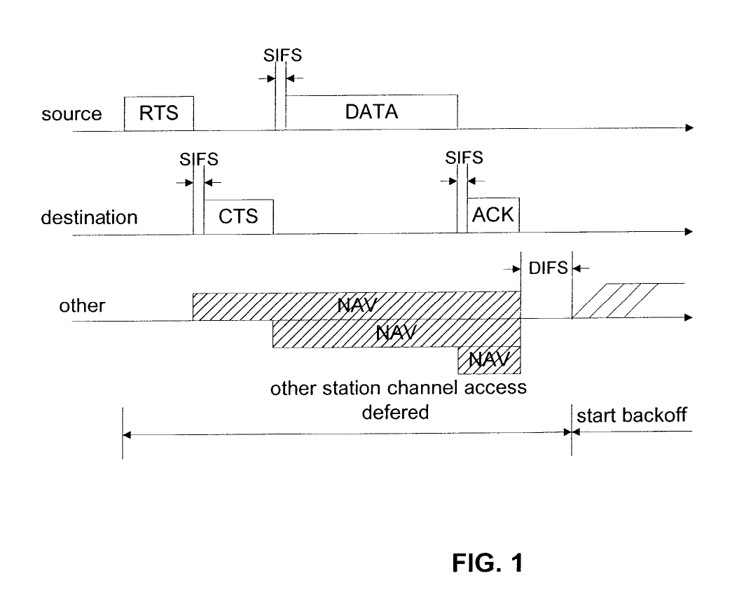

FIG. 2 shows the data frame transmission process of the DCF algorithm according to the prior art;

FIG. 3 shows a k-DCF access mode according to a preferred embodiment of the present invention;

FIG. 4 shows a communication topology as an assumption for a simulation as utilized according to the present invention;

FIG. 5 shows the relation of node number and goodput as comparison between a preferred embodiment of the present invention and the prior art;

FIG. 6 shows the relation of node number and fairness as comparison between a preferred embodiment of the present invention and the prior art;

FIG. 7 shows medium access control (MAC) layer packets dropped for exceeding a retry count limit in a case of 140 nodes as a comparison between a preferred embodiment of the present invention and the prior art;

FIG. 8 shows a delay character comparison between the DCF algorithm according to the prior art and the k-DCF protocol according to the present invention;

FIG. 9 shows the basic principle underlying the algorithm of the method according to the present invention; and

FIG. 10 shows a preferred embodiment of the method according to the present invention concerning each of a plurality of communication nodes in a system.

### DETAILED DESCRIPTION OF THE PREFERRED EMBODIMENTS

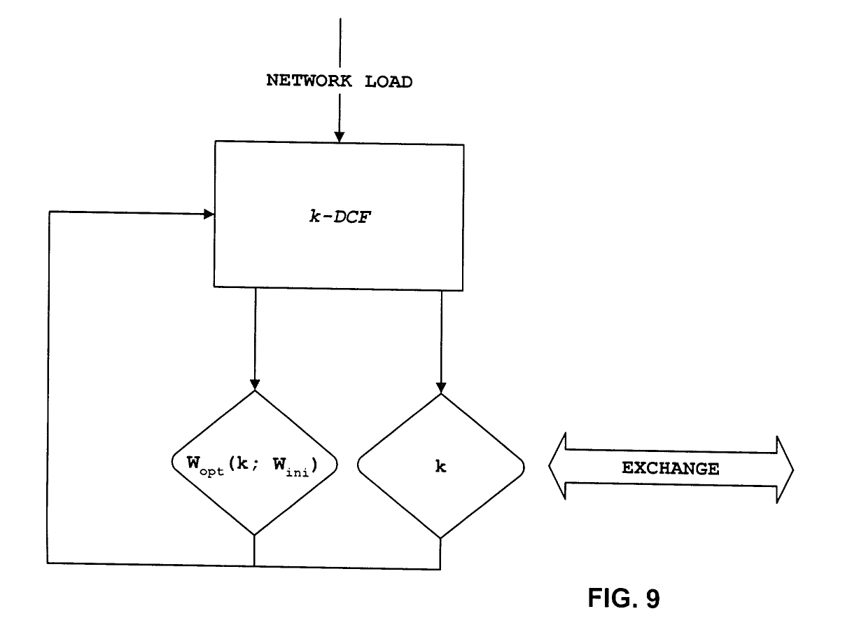

With respect to FIG. 9, the basic principle underlying the algorithm of the method according to the present invention is described.

Specifically, the algorithm (k-DCF) is performed under continuous influence of the network load in a manner so as to be self-adapting to the current network load. As a result of the continuous performance of the algorithm, a collision related parameter (k) is calculated for each concerned communication node which is exchanged with other communication nodes for refreshing the state of the network. Further, also an optimal contention window (Wₒₚₜ(k; Wᵢₙᵢ)) for a transmission of packets is calculated by the algorithm by using the collision related parameter (k) and an initial contention window (Wᵢₙᵢ). With this optimal contention window (Wₒₚₜ(k; Wᵢₙᵢ)), the throughput in a wireless communication network by respective communication nodes is enhanced.

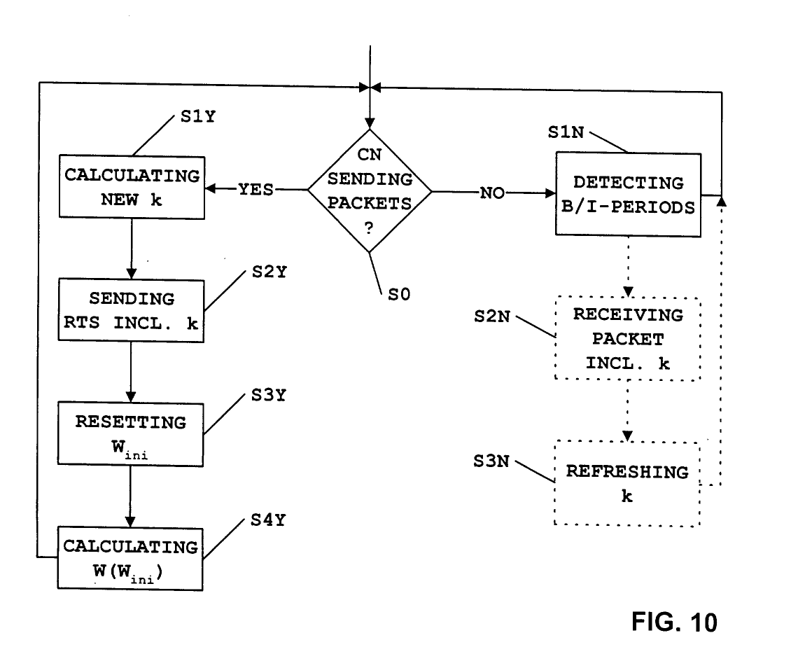

By referring now to FIG. 10, a preferred embodiment of the method according to the present invention is described.

Specifically, considered are detailed steps for each of communication nodes of a system to which the method according to the present invention is applied.

First, there is a step S0 where it is determined whether the communication node (CN) is sending packets or not. As a matter of fact, every state where the respective communication node is sending packets is followed by a state where it is not sending packets and vice-versa. However, albeit it is thus irrespective with which branch to start, a suitable starting point is achieved when the busy and idle periods of a current wireless link are detected in a step S1N, in case the respective communication node is not sending packets (“no”). Then, in a state where the respective communication node is sending packets (“yes”), there is first a step S1Y where a new value for the collision related parameter (k) according to the lengths of the detected busy and idle periods is calculated. This step is followed by a step S2Y where a request to send packets including the calculated new value for the collision related parameter (k) is sent, whereby a respective network state is refreshed and other communication nodes retrieve the value for the collision related parameter (k). Thereafter, an initial contention window (Wᵢₙᵢ) has to be reset in a step S3Y by utilizing the calculated new value for the collision related parameter (k). Before closing the loop, as the designed result, a current contention window (W) for the transmission of packets is calculated in a step S4Y by utilizing the initial window (Wᵢₙᵢ).

Optionally, in the state where the respective communication node is not sending packets (“no”), a packet of another communication node including a value for the collision related parameter (k) can be received in a step S2N. Accordingly, in the respective communication node, a value for the collision related parameter (k) according to the received value can be refreshed thereafter in a step S3N.

A preferred embodiment of the present invention is an improvement of the DCF algorithm as known in the prior art which is described by referring to the accompanying drawings.

### k-DCF Protocol Description

In the following, the k-DCF algorithm is described as a preferred embodiment of the present invention. The k-DCF algorithm is based on the IEEE 802.11 window backoff CSMA/CA algorithm, which is described above in equations (1), (2), (3). If other communication networks use the same MAC algorithm, the present embodiment of the present invention will also be applicable.

According to the analysis of the prior art as described above, the known DCF protocol does not predict or detect the state of current wireless local area networks when using the window contention mechanism. So even if the number of nodes has increased to a very large value, a node uses the same initial contention window to contend for the channel. As a result, a lot of contentions occur and there is a frequent backoff. Hence, the throughput and fairness deteriorate.

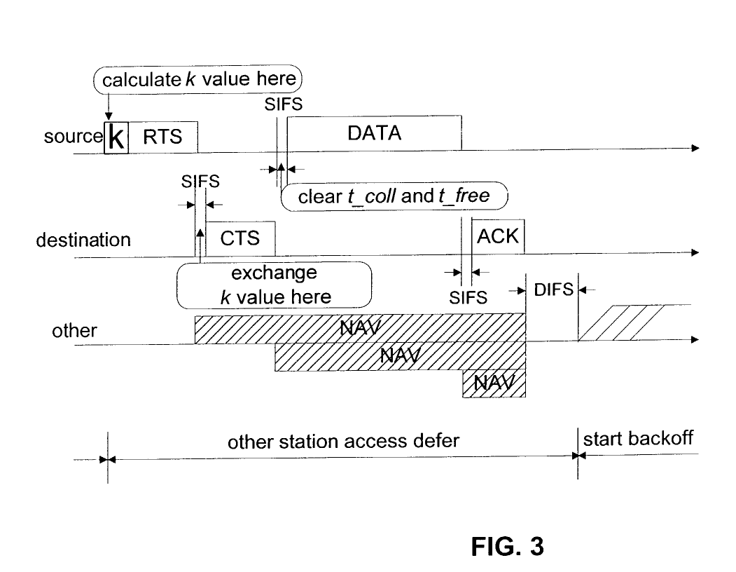

In order to be self-adapting according to the network load, the k-DCF protocol introduces a collision related parameter k that designates the ratio of the collision time length and the idle time length of the wireless channel according to equations (4), (5), and (6) below. Every Request-to-Send (RTS) packet carries the just calculated k parameter value to all other single-hop nodes to refresh the network load state. When a node has data packets to send, it exploits the k value to calculate the optimized initial window size. Here, a uniform k value is used in order to guarantee the fairness of the node access. The option Request-To-Send and Clear-To-Send (RTS/CTS) is used, because the calculation of the optimal k value kₒₚₜ is relative to the collision length. By using RTS/CTS control packets, the collision length is definite and kₒₚₜ is stable. If the RTS sender successfully gets the CTS, it means that the RTS has been successfully sent and the k value is exchanged. Then the sender clears the parameters t_coll (busy time length) and t_free (idle time length) to prepare for the next turn transmission and k calculation. If RTS has encountered a collision, the sender does not get CTS and the k value piggybacked on the collided RTS packet is lost. The successfully transmitted protocol flow of k-DCF is shown in FIG. 3. The modifications to the known DCF algorithm include the calculation of k and the new window calculation algorithm. The calculation of k value is expressed in the following equations (4), (5), (6):

t_coll_avg=α * t_col_avg+(1−α) * t_coll; (4)

t_free_avg=α * t_free_avg+(1−α) * t_free; (5)

if (t_free_avg!=0)&&(t_coll_avg!=0), then

k=λ *k+(1−λ)*t_coll_avg/t_free_avg (6)

wherein t_coll_avg and t_free_avg are average values of t_coll and t_free, respectively. Namely, t_coll and t_free designate a collision time length and a free time length in a virtual transmission time t_v, while λ designates a variation control factor. By using λ, the instability caused by the fluctuation of the k value is avoided.

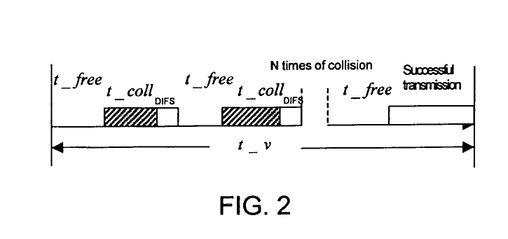

The initial value of k is set to kₒₚₜ (the calculation of value kₒₚₜ is described in detail further below). Every time the node of the network has gained access to the network by a successful transmission sequence of RTS/CTS, it calculates the current k value immediately using the refreshed t_free and t_coll. Then the recalculated k value is piggybacked to the nearby node using the data frame to dynamically refresh the k value of other nodes. At the same time, the node sending data clears t_free and t_coll to make preparation for the calculation in the next virtual transmission time t_v (see FIG. 2). In order to avoid the frequent fluctuation of k value, a parameter α is used to smooth the fluctuation. The new window calculation rules are defined as follows:

aa) The i^{th} time to calculate the initial contention window W¹:

(the calculation of ƒ(k,W) is shown further below)

$${W}^{i} = \{ \begin{matrix}{W}_{min} & i = 0 \\ f ( k , {W}^{i - 1} ) & i > 0\end{matrix} ; \qquad ( 7 )$$

if (W¹>Wm)Wⁱ=Wₘₐₓ; (8)

if (W¹<Wₘᵢₙ)W¹=Wₘᵢₙ. (9)

bb) The window backoff and the backoff time calculation is the same as those in known DCF.

### Calculation of f(k, W)

How to get the optimized initial contention window according to a current k value is a main issue of the mechanism implementation according to the present embodiment. It is assumed that the active node number is N (i.e. N nodes are sending data), the initial window value is W, the optimized window size is Wₒₚₜ a node attempts to access the channel with the probability of τ, and the collision possibility is p. Haitao Wu, Yong Peng, Keping Long, Shiduan Cheng, Jian Ma, (“Performance of Reliable Transport Protocol over IEEE 802.11 Wireless LAN: Analysis and Enhancement”, IEEE Infocom 2002) and Giuseppe Bianchi (“Performance Analysis of the IEEE 802.11 Distributed Coordination Function”, IEEE Journal on selected area in Communication, Vol. 18, No. 3, March 2000) have derived the expression of τ as follows, wherein b_{0.0} is the stable possibility that the time backoff counter is 0 during the first contention of the virtual transmission time t_v, m is the maximum backoff stage and m′ is the backoff stage at which the window increases:

$$\begin{matrix}τ = \frac{1 - {p}^{m + 1}}{1 - p} {b}_{0 , 0} & ( 10 ) \\ {b}_{0 , 0} = \{ \begin{matrix}\frac{2 ( 1 - 2 p ) ( 1 - p )}{W ( 1 - {( 2 p )}^{m + 1} ) ( 1 - p ) + ( 1 - 2 p ) ( 1 - {p}^{m + 1} )} & m \leq {m}^{′} \\ \frac{2 ( 1 - 2 p ) ( 1 - p )}{W ( 1 - {( 2 p )}^{{m}^{′} + 1} ) ( 1 - p ) + ( 1 - 2 p ) ( 1 - {p}^{m + 1} ) + {W2}^{{m}^{′}} {p}^{{m}^{′} + 1} ( 1 - 2 p ) ( 1 - {p}^{m - {m}^{′}} )} & m > {m}^{′}\end{matrix} & ( 11 )\end{matrix}$$

Giuseppe Bianchi, “Performance Analysis of the IEEE 802.11 Distributed Coordination Function”, IEEE Journal on selected area in Communications, Vol. 18, No. 3, March 2000) has also derived the optimal channel access probability corresponding to a maximum throughput, which is useful to a derivation below. T is the number of slots wasted in one collision.

$${τ}_{opt} = \frac{1}{N \sqrt{{T}_{c}^{*} / 2}} \qquad ( 12 )$$

Further, the above modeling conclusions are exploited to derive the expression Wₒₚₜ=ƒ(k,W).

$$\begin{matrix}\begin{matrix}k = \frac{t\_coll \_avg}{t\_free \_avg} = \frac{1 - N {τ ( 1 - τ )}^{N - 1} - {( 1 - τ )}^{N}}{{( 1 - τ )}^{N}} \cdot \frac{{T}_{c}^{*}}{1} \\ Note that τ ⪡ 1 , ∴ {( 1 - τ )}^{N} \approx 1 - N \cdot τ + \frac{N ( N - 1 )}{2} \cdot {τ}^{2} , so \text{:}\end{matrix} & ( 13 ) \\ k = [ \frac{1}{1 - N \cdot τ + \frac{N ( N - 1 )}{2} \cdot {τ}^{2}} - \frac{N \cdot τ}{( 1 - τ )} - 1 ] \cdot {T}_{c}^{*} & ( 14 )\end{matrix}$$

By substituting (12) in (14), the optimal k value is obtained when r is optimal:

$${k}_{opt} \approx [ \frac{\frac{1}{\sqrt{2 {T}_{c}^{*}}} - \frac{1}{{T}_{c}^{*}}}{\sqrt{{T}_{c}^{*} / 2} - 1 + \frac{1}{\sqrt{2 {T}_{c}^{*}}}} ] \cdot {T}_{c}^{*} \qquad ( 15 )$$

The collision length of RTS can be substituted by RTS+EIFS (Extended InterFrame Space). In the environment of DSSS (direct sequence spread spectrum), i.e. a 2 Mbps transmission rate, T_{c}*=(272+248+10+50)/20=29 (slot), that is, according to (15), kₒₚₜ=0.955.

Next, the relation expression of Wₒₚₜ, kₒₚₜ, k, W is derived. To simplify the calculation, the same hypothesis of m=m′=0 as utilized in Giuseppe Bianchi: “Performance Analysis of the IEEE 802.11 Distributed Coordination Function”, IEEE Journal on selected area in Communications, Vol. 18, No. 3, March 2000, is adopted here. From (10), (11) one can obtain:

$$τ = \frac{2 ( 1 - 2 p ) ( 1 - {p}^{m + 1} )}{W ( 1 - {( 2 p )}^{m + 1} ) ( 1 - p ) + ( 1 - 2 p ) ( 1 - {p}^{m + 1} )} {=}^{let {m}^{′} = m = 0} \frac{2}{W + 1} \qquad ( 16 )$$

It can be seen that (16) is just the same as the equation derived in Giuseppe Bianchi: “Performance Analysis of the IEEE 802.11 Distributed Coordination Function”, IEEE Journal on selected area in Communications, Vol. 18, No. 3, March 2000.

$$\begin{matrix}Note that \frac{2}{W - 1} ⪡ 1 , so \text{:} \\ {( 1 + \frac{2}{W - 1} )}^{N} ∼ 1 + N \frac{2}{W - 1} + \frac{N ( N - 1 )}{2} {( \frac{2}{W - 1} )}^{2}\end{matrix} \qquad ( 17 )$$

From (13), (16), (17), one can obtain:

$$k = [ \frac{1}{{( 1 - \frac{2}{W + 1} )}^{N}} - \frac{2 N}{( W - 1 )} - 1 ] \cdot {T}_{c}^{*} \approx \frac{2 N ( N - 1 )}{{( W - 1 )}^{2}} \cdot {T}_{c}^{*} \qquad ( 18 )$$

Let k=kₒₚₜ, W=Wₒₚₜ, one gets

$${k}_{opt} = \frac{2 N ( N - 1 )}{{( {W}_{opt} - 1 )}^{2}} \cdot {T}_{c}^{*} \qquad ( 19 )$$

(18)/(19), one gets:

$$k / {k}_{opt} = \frac{{( {W}_{opt} - 1 )}^{2}}{{( W - 1 )}^{2}} \qquad ( 20 )$$

Rearranging (20), it is finally obtained:

Wₒₚₜ=ƒ(k,W)≈W·\sqrt{k/kₒₚₜ} (21)

Equation (21) shows that there exists a ratio relationship between a current contention window and the optimized contention window, and the coefficient is \sqrt{k/kₒₚₜ}. According to the equation, the k value is identified to dynamically adjust the contention window size in response to the network load. As a result, the maximum throughput is achieved. In order to be compatible with the known DCF algorithm, the k-DCF algorithm according to the present embodiment still uses the known window binary exponential backoff algorithm. Equation (21) is only used to adjust the minimum contention window Wₘᵢₙ, which may bring in some inaccuracy. However, in later simulation it can be seen that this algorithm shows good performance.

The advantage of k-DCF is that it is easy to implement. It needs only some modifications to the medium access control (MAC) layer software in the wireless terminals according to the k-DCF algorithm according to the present embodiment.

### Simulation Model

In the following, a simulation model and corresponding results thereof are described.

To prove the validity of the k-DCF algorithm, the NS (Network Simulator) of the Berkeley University has been used to set up the simulation model. In order to simplify the simulation model, the following hypothesis is assumed:

(1) The research focus is the multi-access aspect of wireless access, so it is assumed that the channel is an ideal one without error. In addition, a “hidden terminal” and an “exposed terminal” are not taken into consideration.

(2) The buffer is large enough and the loss of frame is all due to collision and time-out, which can be easily achieved for nodes.

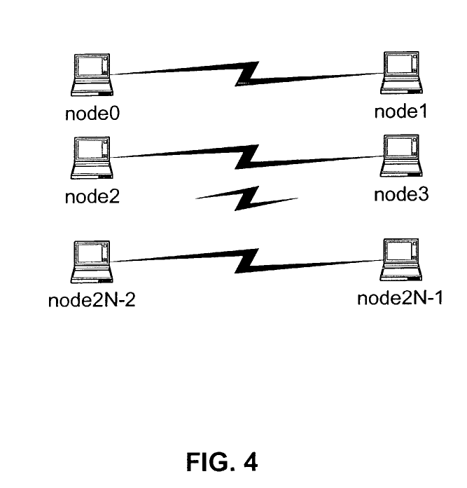

The topology of simulation is N communication pairs as shown in FIG. 4. Here, a TCP connection between the (2N-2)th node and the (2N-1)th node for FTP applications is considered. All odd nodes are at the same place and all even nodes are at another place which is close enough to the odd nodes. The version of TCP shall be NewReno. Important parameters are listed in table 1 below.

TABLE 1

Simulation Parameters

| | |
|---|---|
| Bit rate | 2 Mbps |
| Error rate | 0 |
| Node number 2N | 4, 10, 30, 50, 70, 100 |
| Wₘᵢₙ, Wₘₐₓ | 15, 1023 (k-DCF) 31, 1023 (DCF) |
| FTP start time, stop time | 10.0 s, 35.0 s |
| Smooth parameter α | 0.96 |
| Packet length | 1460 bytes |
| MAC algorithm | DCF & k-DCF (RTS/CTS) |

### Goodput and Fairness

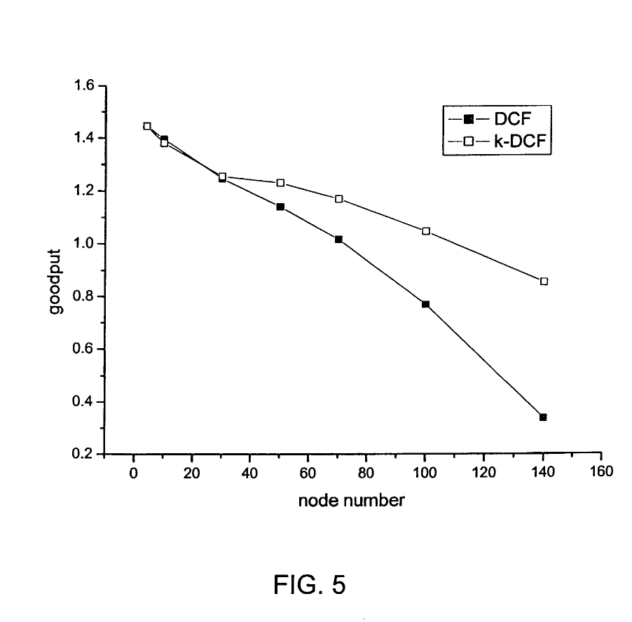

FIG. 5 illustrates the relation curve between node number and goodput which is the throughput without retransmission. Every point shown in FIG. 5 is the mean value of 10 different seeds simulation results. Therefrom, it can be concluded that with the node number increasing, it becomes more and more obvious that the goodput of k-DCF is superior to DCF. With the increase in the number of active nodes, the medium access control (MAC) layer delay also increases, which affects the upper layer TCP throughput. This is also a reason of decrease in goodput of k-DCF and DCF. When the number of nodes is small, especially when it is smaller than 10 nodes, the k value is very low, so the algorithm does not take effect and the k-DCF acted just as the known DCF algorithm.

Further, the fairness of k-DCF and DCF has been also investigated.

The fairness equation according to Jin Xiao-Hui, Li Jian-Dong, Guo Feng (“M-DCF: a MAC protocol implementing QoS in Ad Hoc network”, JOURNAL OF CHINA INSTITUTE OF COMMUNICATIONS, 2001.2) has been used therefor:

$$f = {( {\sum }_{i = 1}^{n} f ( i ) )}^{2} / ( n {\sum }_{i = 1}^{n} {f ( i )}^{2} ) \qquad ( 24 )$$

wherein f denotes fairness, and f(i) denotes the goodput of the i^{th} communication pair.

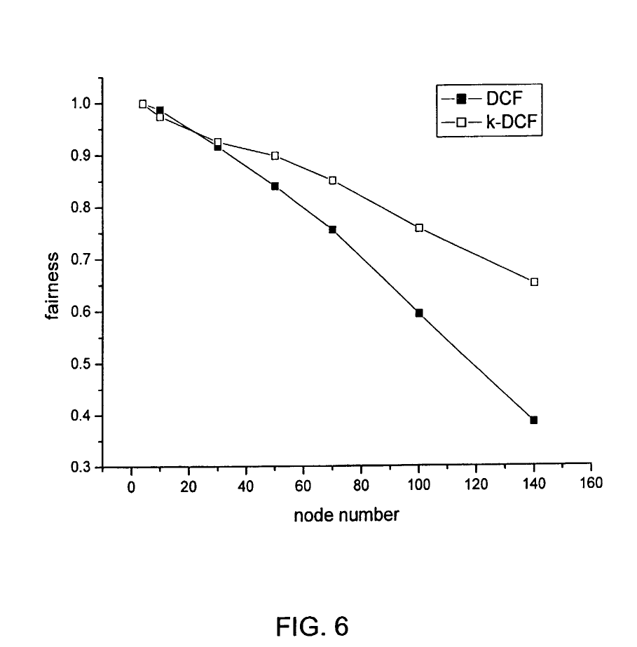

From FIG. 6, it can be seen that k-DCF also performs much better than DCF when the node number is larger than 30 nodes.

### MAC PDU Drop Rate

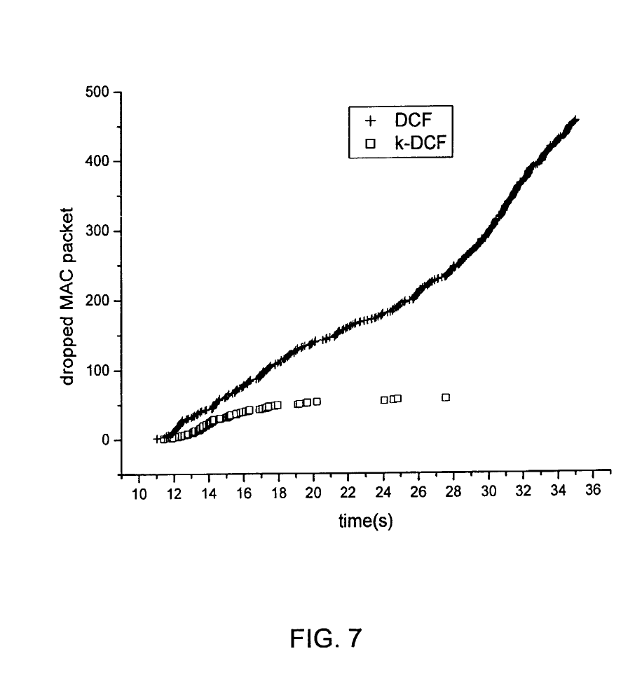

FIG. 7 shows the impact of k-DCF on the loss of packets caused by medium access control (MAC) layer retransmission. As depicted, after some times of window adjust, the packet loss rate of k-DCF algorithm caused by medium access control (MAC) layer retransmission becomes zero, which hide the down layer feature completely to the upper layer. It is especially useful to the upper layer protocols that are sensitive to packet loss (e.g. TCP). The adjust time can be reduced by decreasing the counter maximum m to a relatively small value. In addition, in case of known DCF, the number of dropped packets almost linearly increases as time goes on.

### MAC Layer Access Delay Analysis

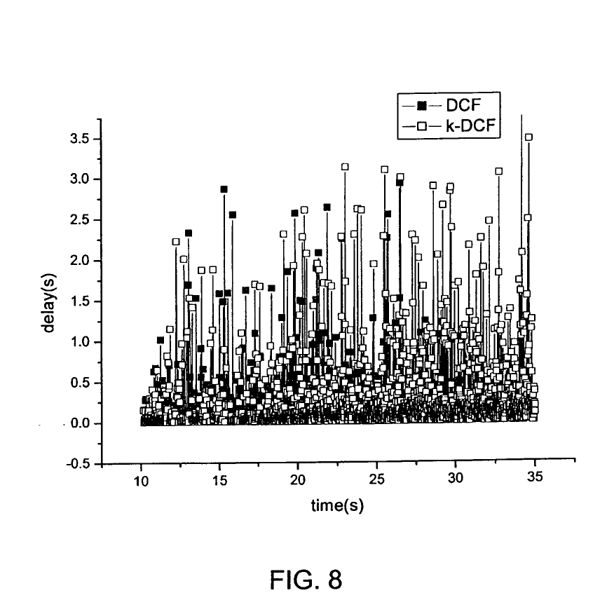

FIG. 8 shows the delay character of DCF and k-DCF in case of 140 nodes. Table 2 shows the statistics of the two medium access control (MAC) access methods. At first sight, the advantage of k-DCF over DCF in delay character cannot be seen. After careful analysis of the data set, one can find that in case of k-DCF 75%*1841=1380 packets have delay bound of 0.26 s, while in known DCF 95%*1011=960 packets have delay bound of 0.79 s. So, the delay character of k-DCF is much better than DCF.

TABLE 2
Statistics of MAC Delay

| | Packet | Mean | 75% | 95% |
|---|---|---|---|---|
| Statistic | number | value | Confidence | Confidence |
| DCF | 1011 | 0.17471 | 0.15745 | 0.79876 |
| k-DCF | 1841 | 0.27102 | 0.26444 | 1.12696 |

Thus, described above is a method of enhancing the throughput in a wireless communication network with an algorithm, wherein the algorithm is self-adapting to the current network load; a collision related parameter is calculated and exchanged for refreshing the state of the network; and an optimal contention window for a transmission of packets is calculated by using the collision related parameter and an initial contention window.

While it has been explained above what is presently considered to be preferred embodiments of the present invention, it is apparent to those skilled in the art that various modifications and equivalents may be made without deviating from the spirit and scope of the present invention as defined in the appended claims.

1. A method of enhancing the throughput in a wireless communication network with an algorithm, wherein
the algorithm is self-adapting to the current network load;
a collision related parameter is calculated and exchanged for refreshing the state of the network; and
an optimal contention window for a transmission of packets is calculated by using the collision related parameter and an initial contention window.

2. The method according to claim 1, wherein the network comprises a plurality of communication nodes, and the method comprises for each of the communication nodes: in a state where a respective communication node is not sending packets,
detecting busy and idle periods of a current wireless link; and
in a state where the respective communication node is sending packets,
calculating first a new value for the collision related parameter according to the lengths of the detected busy and idle periods;
sending a request to send packets including the calculated new value for the collision related parameter (k), whereby a respective network state is refreshed and other communication nodes retrieve the value for the collision related parameter;
resetting an initial contention window by utilizing the calculated new value for the collision related parameter; and
calculating a current contention window for the transmission of packets by utilizing the initial window

3. The method according to claim 2, wherein the method comprises:
in the state where the respective communication node is not sending packets,
receiving a packet of another communication node including a value for the collision related parameter and
refreshing, in the respective communication node, a value for the collision related parameter (k) according to the received value.

4. The method according to claim 2, wherein in the step of calculating first a new value for the collision related parameter k, k is obtained by equations
t_coll_avg=α * t_coll_avg+(1=α) * t_coll;
t_free _avg=α * t_free _avg+(1−α) *t_free;
if (t_free_avg!=0)&&(t_coll-avg!=0), then
k=λ *k+(1−λ) *t_coll_avg/t_free_avg,
wherein t_coll and t_free designate a length of a busy period and an idle period, respectively, t_coll_avg and t_free_avg designate respective average values, α designates a smoothing factor and λ designates a variation control factor.

5. The method according to claim 2, wherein in the step of resetting an initial window w by utilizing the calculated new value for the collision related parameter k, an optimized contention window Wₒₚₜ is obtained by equation
Wₒₚₜ=W·√k/kₒₚₜ,
wherein kₒₚₜ is the optimal value of the collision related parameter k which is defined for the optimal channel access probability of a communication node corresponding to a maximum throughput.

6. The method according to claim 2, wherein the wireless communication network is a wireless local area network.

7. A system for enhancing the throughput in a wireless communication network with an algorithm, comprising
means for performing the algorithm in a manner so as to be self-adapting to the current network load;
means for calculating a collision related parameter and exchanging the collision related parameter for refreshing the state of the network; and
means for calculating an optimal contention window for a transmission of packets by using the collision related parameter and an initial contention window.

8. The system according to claim 7, wherein the network comprises a plurality of communication nodes, and each of the communication nodes comprises:
means for detecting busy and idle periods of a current wireless link;
means for first calculating a new value for the collision related parameter according to the lengths of the detected busy and idle periods;
means for sending a request to send packets including the calculated new value for the collision related parameter;
means for retrieving the value for the collision related parameter;
means for resetting an initial contention window by utilizing the calculated new value for the collision related parameter; and
means for calculating a current contention window for the transmission of packets by utilizing the initial contention window.

9. The system according to claim 7, wherein each of the communication nodes comprises:
means for receiving a packet of another communication node including a value for the collision related parameter; and
means for refreshing a value for the collision related parameter according to the received value.

10. The system according to claim 7, wherein the means for first calculating a new value for the collision related parameter k are implemented so that the new value for the collision related parameter k is obtained by equations
t_coll_avg=α * t_coll_avg+(1−α)* t_coll;
t_free_avg=α * t_free _avg+(1−α)* t_free ;
if (t_free_avg!=0)&&(t_coll-avg!=0), then
k=λ *k+(1−λ)*t_coll_avg/t_free_avg,
wherein t_coll and t_free designate a length of a busy period and an idle period, respectively, t_coll_avg and t_free_avg designate respective average values, α designates a smoothing factor and λ designates a variation control factor.

11. The system according to claim 7, wherein the means for resetting an initial contention window Wᵢₙᵢ by utilizing the calculated new value for the collision related parameter k are implemented so that an optimized contention window Wₒₚₜ is obtained by equation
Wₒₚₜ=W·√k/kₒₚₜ,
wherein kₒₚₜ is the optimal value of the collision related parameter k which is defined for the optimal channel access probability of a communication node corresponding to a maximum throughput.

12. The system according to claim 7, wherein the wireless communication network is a wireless local area network.

13. A communication node for enhancing the throughput in a wireless communication network with an algorithm, comprising
means for performing the algorithm in a manner so as to be self-adapting to the current network load;
means for calculating a collision related parameter and exchanging the collision related parameter for refreshing the state of the network; and
means for calculating an optimal contention window for a transmission of packets by using the collision related parameter and an initial contention window.

14. The communication node according to claim 13, wherein the means for first calculating a new value for the collision related parameter k are implemented so that the new value for the collision related parameter k is obtained by equations
t_coll_avg=α * t_coll_avg+(1−α)* t_-coll;
t_free_avg=α * t_free_avg+(1−α)* t_free;
if (t_free_avg!=0)&&(t_coll_avg!=0), then
k=λ *k+(1−λ)*t_coll_avg/t_free_avg,
wherein t_coll and t_free designate a length of a busy period and an idle period, respectively, t_coll_avg and t_free_avg designate respective average values, α designates a smoothing factor and λ designates a variation control factor.

15. The communication node according to claim 13, wherein the means for resetting an initial contention window Wᵢₙᵢ by utilizing the calculated new value for the collision related parameter k are implemented so that an optimized contention window Wₒₚₜ is obtained by equation
Wₒₚₜ=W·√k/kₒₚₜ,
wherein kₒₚₜ is the optimal value of the collision related parameter k which is defined for the optimal channel access probability of the communication node corresponding to a maximum throughput.

16. The communication node according to claim 13, wherein the wireless communication network is a wireless local area network.

17. A communication node for enhancing the throughput in a wireless communication network with an algorithm, comprising:
means for detecting busy and idle periods of a current wireless link;
means for first calculating a new value for the collision related parameter according to the lengths of the detected busy and idle periods;
means for sending a request to send packets including the calculated new value for the collision related parameter;
means for retrieving the value for the collision related parameter;
means for resetting an initial contention window by utilizing the calculated new value for the collision related parameter; and
means for calculating a current contention window for the transmission of packets by utilizing the initial contention window.

18. The communication node according to claim 17, comprising:
means for receiving a packet of another communication node including a value for the collision related parameter k; and
means for refreshing a value for the collision related parameter according to the received value.
